(19) United States
(12) Patent Application Publication
(10) Pub. No.: US 2020/0314682 A1
(43) Pub. Date: Oct. 1, 2020

(54) BIT RATE CONTROL METHOD, BIT RATE CONTROL DEVICE, AND WIRELESS COMMUNICATION APPARATUS

(71) Applicant: SZ DJI TECHNOLOGY CO., LTD., Shenzhen (CN)

(72) Inventors: Ying CHEN, Shenzhen (CN); Ning MA, Shenzhen (CN); Lei ZHU, Shenzhen (CN)

(21) Appl. No.: 16/900,343

(22) Filed: Jun. 12, 2020

Related U.S. Application Data
(63) Continuation of application No. PCT/CN2017/116818, filed on Dec. 18, 2017.

(51) Int. Cl. H04W 28/02; H04N 19/146; H04N 19/176; H04L 1/20; H04W 80/02; B64C 39/02

(52) U.S. Cl. CPC H04W 28/0257; H04N 19/146; H04N 19/176; B64C 2201/146; H04W 80/02; B64C 39/024; B64C 2201/127; H04L 1/203

(57) ABSTRACT

A bit rate control method includes obtaining a first bit rate control target for a first preset time period and a second bit rate control target for a second preset time period, determining an encoding parameter according to the first bit rate control target and the second bit rate control target, and controlling an encoder to encode video source data using the encoding parameter to encode video source data. The first preset time period is equal to or longer than the second preset time period.

### CROSS-REFERENCE TO RELATED APPLICATION

This application is a continuation of International Application No. PCT/CN2017/116818, filed Dec. 18, 2017, the entire content of which is incorporated herein by reference.

### TECHNICAL FIELD

The present disclosure relates to the wireless image transmission technology field and, more particularly, to a bit rate control method, a bit rate control device, and a wireless communication apparatus.

### BACKGROUND

A digital wireless image transmission system is applied to an apparatus such as a remote-control aircraft, a video surveillance apparatus, a power line inspection apparatus, etc. The digital wireless image transmission system usually includes a transmission terminal and a reception terminal. The transmission terminal usually includes a video source device, a source coding device, a channel coding device, and a radio frequency device. The reception terminal includes a radio frequency device, a channel decoding device, a source decoding device, and a display device.

A function of the source coding device at the transmission terminal is to compress an uncompressed bit stream provided by the video source device into a code stream that can be carried by a wireless channel through a digital video compression algorithm. The source coding device also transmits the compressed code stream to the reception terminal through the channel coding device and the radio frequency device. A bit rate control is a sub-function of the source coding device, which controls a compression ratio after source coding. The bit rate control not only ensures image quality of a video stream and also controls a size of an encoded stream within a capacity of a wireless channel in a current environment. The conventional bit rate control uses a signal control method, such that a user chooses a fixed bit rate of 2 to 3 levels.

Although the above bit rate control method is easy to implement, it is insufficient to cope with environmental changes. The wireless image transmission system does not have a high reliability. For example, with the method using selections of fixed levels, the bit rate may be too low, which wastes the capacity of the wireless channel. Therefore, the user cannot experience a better image transmission quality. The bit rate may also be too high. If the aircraft flies to a certain distance exceeding a capacity limit of the wireless channel, the picture transmission may be stuck or may be lost.

### SUMMARY

Embodiments of the present disclosure provide a bit rate control method. The method includes obtaining a first bit rate control target for a first preset time period and a second bit rate control target for a second preset time period, determining an encoding parameter according to the first bit rate control target and the second bit rate control target, and controlling an encoder to encode video source data using the encoding parameter to encode video source data. The first preset time period is equal to or longer than the second preset time period.

Embodiments of the present disclosure provide an unmanned aerial vehicle (UAV) including an encoder, a wireless communication apparatus, a processor, and a memory. The encoder is configured to encode video source data obtained by the UAV. The wireless communication apparatus is configured to communicate wirelessly with an external apparatus and transmit encoded video source data. The memory storing a program that, when executed by the processor, causes the processor to obtain a first bit rate control target for a first preset time period and a second bit rate control target for a second preset time period, determine an encoding parameter according to the first bit rate control target and the second bit rate control target, and control an encoder to encode video source data using the encoding parameter to encode video source data. The first preset time period is equal to or longer than the second preset time period.

### BRIEF DESCRIPTION OF THE DRAWINGS

FIG. 1 illustrates a schematic diagram of an application scenario of a bit rate control method according to some embodiments of the present disclosure.

FIG. 2 illustrates a flowchart of a bit rate control method according to some embodiments of the present disclosure.

FIG. 3 illustrates a flowchart of another bit rate control method according to some embodiments of the present disclosure.

FIG. 4A illustrates a flowchart of another bit rate control method according to some embodiments of the present disclosure.

FIG. 4B illustrates a schematic diagram of another application scenario of a bit rate control method according to some embodiments of the present disclosure.

FIG. 5 illustrates a schematic structural diagram of a bit rate control device according to some embodiments of the present disclosure.

FIG. 6 illustrates a schematic structural diagram of another bit rate control device according to some embodiments of the present disclosure.

FIG. 7 illustrate a schematic structural diagram of a wireless communication apparatus according to some embodiments of the present disclosure.

FIG. 8 illustrates a schematic structural diagram of a chip according to some embodiments of the present disclosure.

### DETAILED DESCRIPTION OF THE EMBODIMENTS

To make the purposes, technical solutions, and advantages of the present disclosure clearer, the technical solutions in embodiments of the present disclosure are described in conjunction with accompanying drawings in embodiments of the present disclosure. The described embodiments are only some embodiments not all the embodiments of the present disclosure. Based on embodiments of the disclosure, all other embodiments obtained by those of ordinary skill in the art without any creative work are within the scope of the present disclosure.

The term “and/or” referred to in the present specification describes an association relationship between associated objects and indicates three kinds of relationships. For example, A and/or B can represent three situations that A exists alone, both A and B exist, and B exists alone. The symbol “/” generally indicates that the associated objects have an “or” relationship.

FIG. 1 illustrates a schematic diagram of an application scenario of a bit rate control method according to some embodiments of the present disclosure. As shown in FIG. 1, the bit rate control method of the present disclosure can be applied to a digital wireless image transmission system. The digital wireless image transmission system includes a transmission terminal 1 and a reception terminal 2. The transmission terminal 1 compresses an uncompressed bit stream through a digital video compression algorithm into a bit stream that a wireless channel can carry. The transmission terminal 1 then transmits the compressed bit stream to the reception terminal 2. The transmission terminal 1 can realize a long-term control and a short-term control of encoding through the bit rate control method of the present disclosure. By using a first bit rate control target to perform the long-term control of the encoding, the bit rate control method can flatten an output of the bit rate control, avoid an inconsistent output quality caused by frequent changes of an encoding bit stream, and improve a subjective experience. By using a second bit rate control target to perform the short-term control of the encoding, the bit rate control method can ensure a smoothness of a video, effectively avoid the image transmission from being stuck and being lost, and improve the reliability of the wireless image transmission. Specific implementations of the bit rate control method of the present disclosure are described by following embodiments.

The digital video compression algorithm according to embodiments of the present disclosure can use a digital video compression algorithm of the existing technology.

An apparatus using the above digital video compression algorithm may be a remote-control aircraft, a video surveillance apparatus, or a power line inspection apparatus, etc. For example, when the device using the digital video compression algorithm is a remote-control aircraft, the transmission terminal 1 may be a racing drone and the reception terminal 2 may be a remote controller or first-person view (FPV) goggles.

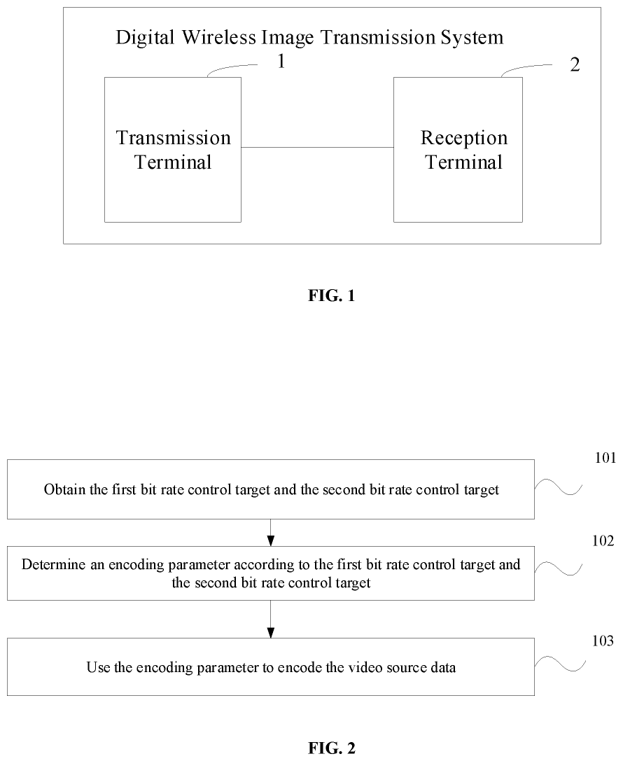

FIG. 2 illustrates a flowchart of a bit rate control method according to some embodiments of the present disclosure. As shown in FIG. 2, the method includes following processes.

At 101, the first bit rate control target and the second bit rate control target are obtained.

In some embodiments, the first bit rate control target and the second bit rate control target may be values or value ranges.

The first bit rate control target is a bit rate control target within a first preset time period. The second bit rate control target is a bit rate control target within a second preset time period. The first time period is not shorter than the second time period. That is, the bit rate control targets for two time windows, the first preset time period and the second present time period, are provided.

One implementation is that each of the first preset time period and the second time period includes a start time point and an end time point. Another implementation is that each of the first preset time period and the second time period includes a start time point and a time duration. Specific settings of the first preset time period and the second time period can be flexibly selected as needed. The time durations of the first preset time period and the second time period can be set flexibly as needed.

At 102, an encoding parameter is determined according to the first bit rate control target and the second bit rate control target.

In some embodiments, a value range or a specific value of the encoding parameter used in an encoding process is determined according to the first bit rate control target and the second bit rate control target. For example, the encoding parameter used by the digital video compression algorithm may be flexibly set according to a specific required digital video compression format.

At 103, the encoding parameter is used to encode the video source data.

The video source data may be the uncompressed bit stream.

In some embodiments, the encoding parameter is determined according to the first bit rate control target and the second bit rate control target, and is used to encode the video source data. The first bit rate control target is the bit rate control target in the first preset time period. The second bit rate control target is the bit rate control target in the second preset time period. The first preset time period is not shorter than the second preset time period. The method further includes determining the encoding parameter according to the bit rate control targets of the two time windows of the first preset time period and the second preset time period. The method realizes the long-term and short-term controls of the encoding. By using the first bit rate control target for the long-term control of the encoding, the method can flatten the output of the bit rate control, avoid the inconsistent output quality caused by the frequent changes of the encoding bit stream, and improve the subjective experience. By using the second bit rate control target for the short-term control of the encoding, the method ensures the smoothness of the video, effectively avoids the image transmission from being stuck and being lost, and improves the reliability of the wireless image transmission.

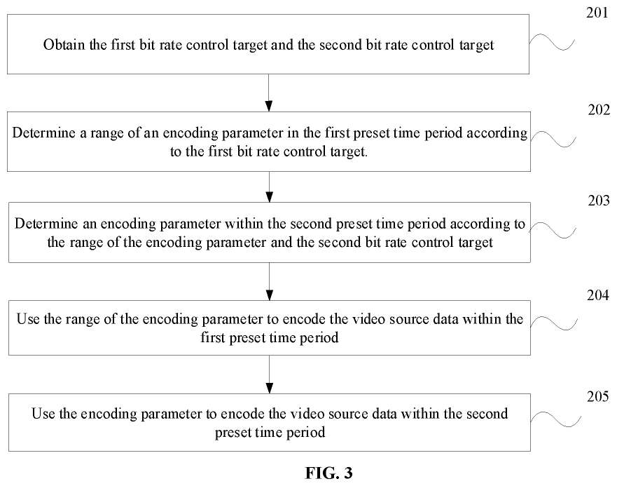

FIG. 3 illustrates a flowchart of another bit rate control method according to some embodiments of the present disclosure. As shown in FIG. 3, the method includes following processes.

At 201, the first bit rate control target and the second bit rate control target are obtained.

For the description of the process 201, reference can be made to the description of the process 101, which is not repeated here.

At 202, a range of the encoding parameter is determined in the first preset time period according to the first bit rate control target.

In some embodiments, according to the first bit rate control target, the value range of the encoding parameter used to encode the video source data within the first preset time period is determined. For example, the first bit rate control target is 1 Mbps to 1.2 Mbps, that is, a bit rate of encoded data within the first preset time period needs to be in the range of 1 Mbps to 1.2 Mbps. The range of the encoding parameter within the first preset time period is determined according to the first bit rate control target, such that the bit rate of the encoded data satisfies the first bit rate control target.

At 203, an encoding parameter within the second preset time period is determined according to the range of the encoding parameter and the second bit rate control target.

The encoding parameter of process 203 is within the encoding parameter range of process 202.

For example, the second bit rate control target is 1.01 Mbps, that is, a bit rate of encoded data within the second time period needs to be 1.01 Mbps. Embodiments of the present disclosure determine the encoding parameter within the second preset time period according to the second bit rate control target. The encoding parameter is within the range of the encoding parameter, such that the bit rate of the encoded data satisfies the first bit rate control target and the second bit rate control target.

At 204, the range of the encoding parameter is used to encode the video source data within the first preset time period.

In some embodiments, using the range of the encoding parameter to encode the video source data within the first preset time period indicates that the value of the encoding parameter used to encode the video source data within the first preset time period is within the range of the encoding parameter. For example, an output bit rate corresponding to the encoding parameter range is from 1 Mbps to 1.2 Mbps. The encoding parameter may change within the first preset time period, but the bit rate corresponding to the encoding parameter at any time during the period is within this range.

At 205, the encoding parameter is used to encode the video source data within the second preset time period.

In some embodiments, using the encoding parameter to encode the video source data within the second preset time period indicates that the encoding parameter in the range of the encoding parameter is used to encode the video source data within the second preset time period. The second preset time period is shorter than the first preset time period. In some embodiments, the video source data within the second preset time period may be one frame of the video source data.

In some embodiments, the range of the encoding parameter within the first preset time period is determined according to the first bit rate control target. According to the encoding parameter range and the second bit rate control target, the encoding parameter within the second preset time period is determined, the range of the encoding parameter is used to encode the video source data within the first preset time period, and the encoding parameter is used to encode the video source data within the second preset time period. The first bit rate control target is the bit rate control target within the first preset time period. The second bit rate control target is the bit rate control target within the second preset time period. The first preset time period is not shorter than the second preset time period. The range of the encoding parameter and the encoding parameter is determined according to two time windows of the first preset time period and the second preset time period. The long-term and short-term controls of the encoding are realized. By using the first bit rate control target for the long-term control of the encoding, the output of the bit rate control is flattened, the inconsistent output quality caused by the frequent changes of the encoding bit stream is avoided, and the subjective experience is improved. By using the second bit rate control target for the short-term control of the encoding, the smoothness of the video is ensured, the image transmission is effectively avoided from being stuck and being lost, and the reliability of the wireless image transmission is improved.

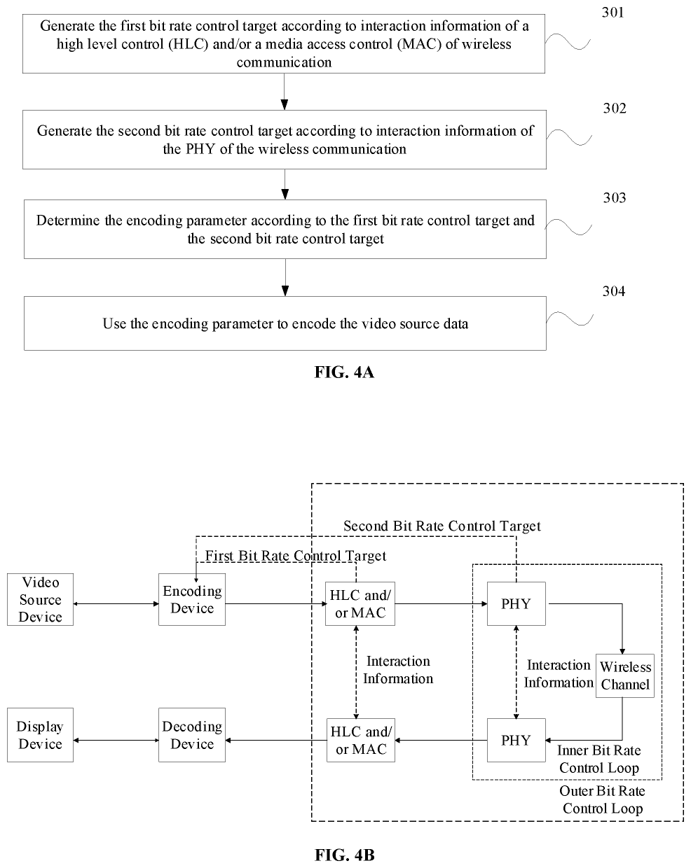

FIG. 4A illustrates a flowchart of another bit rate control method according to some embodiments of the present disclosure. FIG. 4B illustrates a schematic diagram of another application scenario of a bit rate control method according to some embodiments of the present disclosure. As shown in FIG. 4A, the method includes following processes.

At 301, the first bit rate control target is generated according to interaction information of a high level control (HLC) and/or a media access control (MAC) of a wireless communication.

In some embodiments, the first bit rate control target can be generated according to the interaction information of the HLC and/or the MAC of the wireless communication. For the description of the first bit rate control target, reference may be made to the description of the above embodiments, which is not repeated here.

For example, as shown in FIG. 4B, the upper half is the transmission terminal, and the lower half is the reception terminal. The transmission terminal includes a video source device, an encoding device, an HLC and/or MAC circuit, and a physical layer (PHY) circuit. Correspondingly, the reception terminal includes a display device, a decoding device, an HLC and/or MAC circuit, and a PHY circuit. The HLC and/or MAC circuit at the transmission terminal can interact with the HLC and/or MAC circuit at the reception terminal, such that the reception terminal obtains the first bit rate control target.

In some embodiments, the interaction information of the HLC and/or MAC may include at least one of BLock Error Rate (BLER) statistics or application layer throughput statistics. Using the BLER statistics or application layer throughput statistics can reflect an overall quality of the wireless communication within the first preset time period, that is, an approximate range of the wireless channel capacity. The first bit rate control target generated accordingly can ensure that the bit rate is controlled to be within the range allowed by the overall quality of the current wireless communication, and enable the bit rate control to make full use of the current wireless channel capacity to obtain an effective and smooth wireless image transmission bit stream.

In some embodiments, the first bit rate control target can be generated according to a modulation mode of the transmission terminal and/or an encoding block selection parameter. The bit rate control can match a current wireless communication channel according to information statistics of wireless communication channels. At the same time, the bit rate control may also make reference to hardware setting and the modulation mode of the transmission terminal of the wireless communication. In some embodiments, the first bit rate control target can be generated according to the interaction information of the HLC and/or MAC of the wireless communication and the modulation mode and/or the encoding block selection parameter at the transmission terminal.

At 302, the second bit rate control target is generated according to interaction information of the PHY of the wireless communication.

In some embodiments, the second bit rate control target of the above embodiments is generated according to the interaction information of the PHY of the wireless communication. For the description of the second bit rate control target, reference may be made to the description of the above embodiments, which is not repeated here.

For example, as shown in FIG. 4B, the PHY circuit at the transmission terminal may interact with the PHY circuit at the reception terminal, such that the reception terminal obtains the second bit rate control target.

In some embodiments, the interaction information of the PHY may include at least one of a strength change of a wireless signal or a signal-to-noise ratio change of the wireless signal. Using the strength change of the wireless signal or the signal-to-noise ratio change of the wireless signal can effectively reflect the interaction of the wireless communication PHY within the second preset time period. The interaction of the PHY reflects real-time or short-term fluctuations and changes of the wireless signal. These short-term fluctuations and changes of the wireless signal are still within a range of the overall quality of the wireless communication. The method includes generating the second bit rate control target according to the strength change of the wireless signal or the signal-to-noise ratio change of the wireless signal. The method can ensure the bit rate control match a quality of the current wireless signal in a short time. Therefore, the method can avoid situations that the picture transmission is stuck, drops frames, etc., caused by the bit rate not being able to effectively follow a control under the fluctuations and changes of the wireless signal. As such, the method ensures the smoothness and reliability of the wireless image transmission.

In some embodiments, the second bit rate control target is also generated according to the modulation mode and/or the encoding block selection parameter at the transmission terminal. The bit rate control can match the current wireless communication channel according to the information statistics of the wireless communication channels. At the same time, the bit rate control may also make reference to the hardware setting and the modulation mode at the transmission terminal of the wireless communication. In some embodiments, the second bit rate control target can be generated according to the interaction information of the wireless communication PHY and the modulation mode and/or the encoding block selection parameter at the transmission terminal.

The order of process 301 and process 302 is not limited by the order of the numbers.

At 303, the encoding parameter is determined according to the first bit rate control target and the second bit rate control target.

For example, as shown in FIG. 4B, the encoding parameter is determined for an encoder shown in FIG. 4B according to the first bit rate control target and the second bit rate control target.

At 304, the encoding parameter is used to encode the video source data.

In some embodiments, the encoder can use the encoding parameter to encode the video source data sent by the video source device. The encoder can also transmit the encoded data to the reception terminal through the wireless channel.

As shown in FIG. 4B, the PHY circuit and the wireless channel at the transmission terminal, and the PHY circuit at the reception terminal form an inner bit rate control loop. The inner bit rate control loop can track the strength changes of the short-term wireless signal and the signal-to-noise ratio changes of the wireless signal, provide a short-term (the second preset time period) bit rate prediction, and generate the second bit rate control target. The HCL and/or MAC circuit, the PHY circuit, and the wireless channel at the transmission terminal, and the PHY circuit, the HLC and/or MAC circuit at the reception terminal form an outer bit rate control loop. The outer bit rate control loop can provide a long-term (the first preset time period) bit rate prediction and generate the first bit rate control target.

In the embodiments, the outer bit rate control loop can generate the first bit rate control target according to the interaction with the higher level control layer and/or link access layer of the wireless communication. The inner bit rate control loop can generate the second bit rate control target according to the interaction with the PHY of the wireless communication. The encoding parameter is determined according to the first bit rate control target and the second bit rate control target. The encoder uses the encoding parameter to encode video source data. In some embodiments, the first bit rate control target is the bit control target in the first preset time period, and the second bit rate control target is the bit control target in the second preset time period. The first preset time period is not shorter than the second preset time period. According to the bit rate control targets of the two time windows of the first preset time period and the second preset time period, the method includes determining the encoding parameter and realizing the long-term and short-term controls of the encoding. By using the first bit rate control target for the long-term control of the encoding, the method can flatten the output of the bit rate control, avoid the inconsistent output quality caused by the frequent changes of the encoding bit stream, and improve the subjective experience. By using the second bit rate control target for the short-term control of the encoding, the method ensures the smoothness of the video, effectively avoids the image transmission from being stuck and being lost, and improves the reliability of the wireless image transmission.

According to at least one of the BLER statistics or the application layer throughput statistics, the outer bit rate control loop generates the first bit rate control target. The first bit rate control target can ensure that the bit rate is controlled to be within the range allowed by the overall quality of the current wireless communication, and enable the bit rate control to make full use of the current wireless channel capacity to obtain an effective and smooth wireless image transmission bit stream. As such, the method can avoid the inconsistent output quality caused by the frequent changes of the encoding bit stream. According to at least one of the strength change of the wireless signal or the signal-to-noise ratio change of the wireless signal, the inner bit rate control loop generates the second rate control target. The second bit rate control target ensures the bit rate control match the quality of the current wireless signal in a short time. Therefore, the method can avoid situations that the picture transmission is stuck, drops frames, etc., caused by the bit rate not being able to effectively follow a control under the fluctuations and changes of the wireless signal. As such, the method ensures the smoothness and reliability of the wireless image transmission.

The outer bit rate control loop and the inner bit rate control loop can improve robustness of the wireless image transmission system using the bit rate control method of the embodiments. Thereby, the method can effectively cope with various channel changes and wireless environment interferences.

In some embodiments, “avoid inconsistent output quality due to frequent changes of the encoding bit stream” refers to avoiding a large difference in the output quality due to the frequent changes of the encoding bit stream. The difference usually refers to a difference that a user can perceive. For example, the user perceives that the image is suddenly clear and blurry.

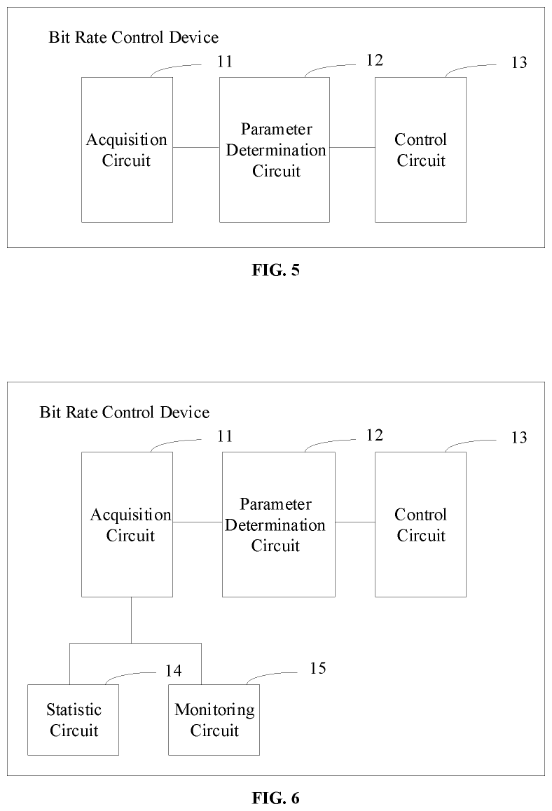

FIG. 5 illustrates a schematic structural diagram of a bit rate control device according to some embodiments of the present disclosure. The bit rate control device is configured for the wireless communication. As shown in FIG. 5, the device includes an acquisition circuit 11, a parameter determination circuit 12, and a control circuit 13. The acquisition circuit 11 is configured to obtain the first bit rate control target and the second bit rate control target. The parameter determination circuit 12 is configured to determine the encoding parameter according to the first bit rate control target and the second bit rate control target. The control circuit 13 is configured to control the encoder and cause the encoder to use the encoding parameter to encode the video source data.

The first bit rate control target is the bit rate control target within the first preset time period. The second bit rate control target is the bit rate control target within the second preset time period. The first preset time period is not shorter than the second preset time period.

In some embodiments, the parameter determination circuit 12 is configured to determine the range of the encoding parameter within the first preset time period according to the first bit rate control target, and determine the encoding parameter within the second preset time period according to the range of the encoding parameter and the second bit rate control target.

In some embodiments, the encoding parameter is in the range of the encoding parameter.

In some embodiments, the control circuit 13 is configured to control the encoder to use the range of the encoding parameter to encode the video source data within the first preset time period, and to use the encoding parameter to encode the video source data within the second preset time period.

In some embodiments, the acquisition circuit 11 is configured to generate the first bit rate control target according to the interaction information of the HLC and/or MAC of the wireless communication.

In some embodiments, the acquisition circuit 11 is configured to generate the second bit rate control target according to the interaction information of the PHY of the wireless communication.

The device of the embodiments may be configured to execute the above technical solutions of the method embodiments. The implementation principles and technical effects are similar, which are not repeated here.

FIG. 6 illustrates a schematic structural diagram of another bit rate control device according to some embodiments of the present disclosure. As shown in FIG. 6, based on the structure of the device shown in FIG. 5, the device further includes a statistics circuit 14 and a monitoring circuit 15. The statistics circuit 14 is configured to count at least one of the BLER statistics or application layer throughput statistics in the first preset time period. The interaction information of the HLC and/or MAC includes at least one of the BLER statistics or application layer throughput statistics.

In some embodiments, the acquisition circuit 11 is further configured to generate the first bit rate control target according to the modulation mode and/or the encoding block selection parameter at the transmission terminal.

The monitoring circuit 15 is configured to monitor at least one of the strength of the wireless signal or the signal-to-noise ratio of the wireless signal within the second preset time period. The interaction information of the PHY includes at least one of the strength change of the wireless signal, or the signal-to-noise ratio change of the wireless signal.

In some embodiments, the acquisition circuit 11 is further configured to generate the second bit rate control target according to the modulation mode and/or the encoding block selection parameter at the transmission terminal.

The device may be configured to execute the technical solutions of the above method embodiments. The implementation principles and the technical effects of the technical solutions are similar, which are not repeated here.

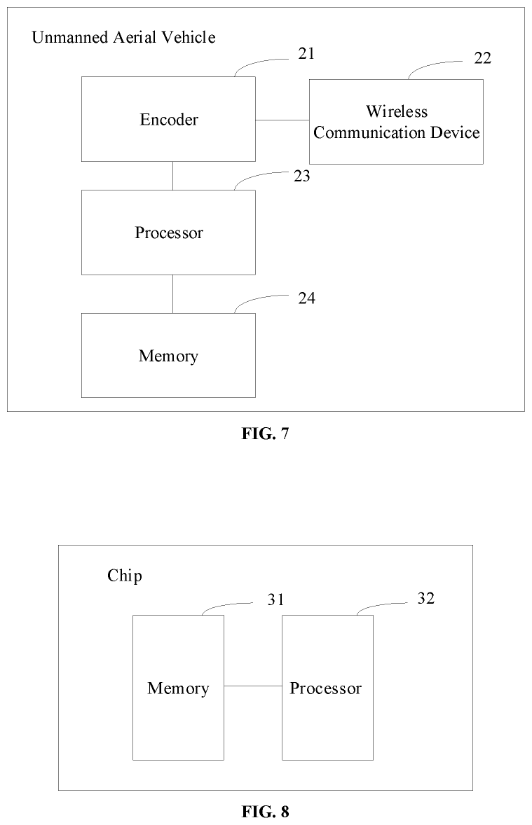

FIG. 7 illustrate a schematic structural diagram of a wireless communication apparatus according to some embodiments of the present disclosure. As shown in FIG. 7, the UAV of the embodiments includes an encoder 21, a wireless communication apparatus 22, a processor 23, and memory 24. The encoder 21 is configured to encode the video source data obtained by the UAV. The wireless communication apparatus 22 is configured to communicate wirelessly with external apparatus and transmit the encoded video source data. The memory 24 is configured to store a program. The processor 23 is configured to execute the program. The program is executed to obtain the first bit rate control target and the second bit rate control target, determine the encoding parameter according to the first bit rate control target and the second bit rate control target, and control the encoder to encode the video source data using the encoding parameter. The first bit rate control target is the bit rate control target within the first preset time period. The second bit rate control target is the bit rate control target within the second preset time period. The first preset time period is not shorter than the second preset time period.

In some embodiments, the program is further executed to determine the range of the encoding parameter within the first preset time period according to the first bit rate control target, and determine the encoding parameter within the second preset time period according to the range of the encoding parameter and the second bit rate control target.

In some embodiments, the encoding parameter is within the range of the encoding parameter.

In some embodiments, the program is further executed to use the range of the encoding parameter to encode the video source data within the first preset time period and use the encoding parameter to encode the video source data within the second preset time period.

In some embodiments, the program is further executed to generate the first bit rate control target according to the interaction information of the HLC and/or MAC of the wireless communication.

In some embodiments, the interaction information of the HLC and/or MAC includes at least one of the BLER statistics or application layer throughput statistics.

In some embodiments, the program is further executed to generate the first bit rate control target according to the modulation mode and/or the encoding block selection parameter at the transmission terminal.

In some embodiments, the program is further executed to generate the second bit rate control target according to the interaction information of the PHY of the wireless communication.

In some embodiments, the interaction information of the PHY includes at least one of the strength change of the wireless signal or the signal-to-noise ratio change of the wireless signal.

In some embodiments, the program is further executed to generate the second bit rate control target according to the modulation mode and/or the encoding block selection parameter at the transmission terminal.

The UAV of the embodiments may be configured to execute the technical solutions of the above method embodiments. The implementation principles and technical effects are similar, which are not repeated here.

FIG. 8 illustrates a schematic structural diagram of a chip according to some embodiments of the present disclosure. The chip may be a chip of the wireless image transmission system. The chip includes a memory 31 and a processor 32. The memory 31 is communicatively connected to the processor 32.

The memory 31 is configured to store program instructions. The processor 32 is configured to execute the program instructions in the memory 31 to implement a method consistent with the disclosure, such as one of the above-described example methods.

In some embodiments, the chip may be configured to implement the technical solutions of the above method embodiments. The implementation principles and technical effects are similar, which are not repeated here.

In some embodiments, the program instructions may be implemented in the form of a software functional unit and can be sold or used as an independent product. The memory 31 may be a computer-readable storage medium of any form. All or part of the technical solution of the present disclosure may be implemented in the form of a software product, including several instructions, which enable a computer device, in some embodiments, a processor 32, to perform all or part of the processes in the embodiments of the present disclosure. The computer-readable storage medium includes various media that can store program codes, such as a U disk, a mobile hard disk, a read-only memory (ROM), a random-access memory (RAM), a magnetic disk, or an optical disk.

In the embodiment of the present disclosure, a division of the modules are illustrative, which is only a logical function division, and the actual implementation may have another division method. In the embodiment of the disclosure, individual functional modules can be integrated in one processing module, or can be individual units physically separated, or two or more units can be integrated in one unit. The integrated units above can be implemented by hardware or can be implemented by hardware and software functional units.

When the integrated modules are implemented by software functional modules and sold and used as an individual product, the integrated modules can be stored in a computer-readable storage medium. The essence of the technical solutions of the present disclosure, a part contributing to the existing technology, or all or part of the technical solutions can be implemented in the form of a software product. The software product stored in a storage medium includes a plurality of instructions for a computing device (such as a personal computer, a server, or network device, etc.) or a processor to execute some of the operations in the embodiments of the disclosure. The storage medium includes USB drive, mobile hard disk, ROM, RAM, disk or optical disk, or another medium that can store program codes.

In some embodiments, all or part of the technical solutions can be implemented by software, hardware, firmware, or any combination thereof. When implemented by software, all or part of the technical solutions can be implemented in the form of a computer program product. The computer program product includes one or more computer instructions. When the computer program instructions are loaded and executed on the computer, all or part of the processes or functions are generated according to the embodiments of the present disclosure. The computer may be a general-purpose computer, a special-purpose computer, a computer network, or other programmable devices. The computer instructions may be stored in a computer-readable storage medium or transmitted from one computer-readable storage medium to another computer-readable storage medium. For example, the computer instructions may be from a website site, a computer, a server, or a data center transmit data another website, a computer, a server, or a data center through a wired (e.g., a coaxial cable, an optical fiber, a digital subscriber line (DSL)) or a wireless (e.g., infrared, wireless, microwave, etc.) method. The computer-readable storage medium may be any available medium that can be accessed by a computer or a data storage device including a server, a data center, etc., integrated with one or more available media. The available medium may be a magnetic medium (e.g., a floppy disk, a hard disk, a magnetic tape), an optical medium (e.g., a DVD), or a semiconductor medium (e.g., a solid state disk (SSD)).

Those skilled in the art can understand that, for convenient and simple description, the division of individual functional modules are described as an example. In some embodiments, the functions above can be assigned to different functional modules for implementation, i.e., the internal structure of the device can be divided into different functional modules to implement all or some of the functions described above. For the specific operation process of the device described above, reference can be to the corresponding process in the method embodiments, which is not be described in detail here.

The embodiments are merely used to describe the technical solutions of the disclosure but not used to limit the disclosure. Although the disclosure is described in detail referring to the individual embodiments, one of ordinary skill in the art should understand that it is still possible to modify the technical solutions in the embodiments, or to replace some or all of the technical features. However, these modifications or substitutions do not cause the essence of the corresponding technical solution to depart from the scope of the technical solutions in the individual embodiments of the disclosure.

What is claimed is:

1. A bit rate control method comprising:
obtaining a first bit rate control target for a first preset time period and a second bit rate control target for a second preset time period, the first preset time period being equal to or longer than the second preset time period;
determining an encoding parameter according to the first bit rate control target and the second bit rate control target; and
controlling an encoder to encode video source data using the encoding parameter to encode video source data.

2. The method of claim 1, wherein determining the encoding parameter according to the first bit rate control target and the second bit rate control target includes:
determining a value range of the encoding parameter within the first preset time period according to the first bit rate control target; and
determining a value of the encoding parameter within the second preset time period according to the value range of the encoding parameter and the second bit rate control target.

3. The method of claim 2, wherein the value of the encoding parameter is within the value range of the encoding parameter.

4. The method of claim 2, wherein controlling the encoder to encode the video source data using the encoding parameter includes controlling the encoder to:
encode the video source data within the first preset time period using the value range of the encoding parameter; and
encode the video source data within the second preset time period using the value of the encoding parameter.

5. The method of claim 1, wherein obtaining the first bit rate control target includes generating the first bit rate control target according to interaction information of at least one of a high level control (HLC) or a media access control (MAC) of a wireless communication.

6. The method of claim 5, wherein the interaction information includes at least one of block error rate (BLER) statistics or application layer throughput statistics.

7. The method of claim 5, wherein obtaining the first bit rate control target further includes generating the first bit rate control target according to at least one of a modulation mode or an encoding block selection parameter at a transmission terminal.

8. The method of claim 1, wherein obtaining the second bit rate control target includes generating the second bit rate control target according to interaction information of a physical layer (PHY) of a wireless communication.

9. The method of claim 8, wherein the interaction information of the PHY includes at least one of a strength change of the wireless communication or a signal-to-noise ratio change of the wireless communication.

10. The method of claim 8, wherein obtaining the second bit rate control target further includes generating the second bit rate control target according to a modulation mode or an encoding block selection parameter at a transmission terminal.

11. An unmanned aerial vehicle (UAV) comprising:
an encoder configured to encode video source data obtained by the UAV;
a wireless communication apparatus configured to communicate wirelessly with an external apparatus and transmit encoded video source data;
a processor; and
a memory storing a program that, when executed by the processor, causes the processor to:
obtain a first bit rate control target for a first preset time period and a second bit rate control target for a second preset time period, the first preset time period being equal to or longer than the second preset time period;
determine an encoding parameter according to the first bit rate control target and the second bit rate control target; and
control the encoder to encode the video source data using the encoding parameter.

12. The UAV of claim 11, wherein the program further causes the processor to:
determine a value range of the encoding parameter within the first preset time period according to the first bit rate control target; and
determine a value of the encoding parameter within the second preset time period according to the value range of the encoding parameter and the second bit rate control target.

13. The UAV of claim 12, wherein the value of the encoding parameter is within the value range of the encoding parameter.

14. The UAV of claim 12, wherein the program further causes the processor to:
encode the video source data within the first preset time period using the value range of the encoding parameter; and
encode the video source data within the second preset time period using the encoding parameter.

15. The UAV of claim 11, wherein the program further causes the processor to:
generate the first bit rate control target according to interaction information of at least one of a high level control (HLC) or a media access control (MAC) of a wireless communication.

16. The UAV of claim 15, wherein the interaction information includes at least one of block error rate (BLER) statistics or application layer throughput statistics.

17. The UAV of claim 15, wherein the program further causes the processor to generate the first bit rate control target according to at least one of a modulation mode or an encoding block selection parameter at a transmission terminal.

18. The UAV of claim 1, wherein the program further causes the processor to generate the second bit rate control target according to interaction information of a physical layer (PHY) of a wireless communication.

19. The UAV of claim 8, wherein the interaction information of the PHY includes at least one of a strength change of the wireless communication or a signal-to-noise ratio change of the wireless communication.

20. The UAV of claim 8, wherein the program further causes the processor to generate the second bit rate control target according to a modulation mode or an encoding block selection parameter at a transmission terminal.
